(19) United States
(12) Patent Application Publication
(10) Pub. No.: US 2026/0223001 A1
(43) Pub. Date: Jul. 30, 2026

(54) POWER SUPPLY CONTROL DEVICE AND METHOD FOR DRIVING CRIME PREVENTION APPLICATION IN SMART TERMINAL

(71) Applicants: Dong-Sik KIM, Seoul (KR); Han Seok KIM, Seoul (KR)

(72) Inventors: Dong-Sik KIM, Seoul (KR); Han Seok KIM, Seoul (KR)

(21) Appl. No.: 19/144,441

(22) PCT Filed: Dec. 28, 2023
(86) PCT No.: PCT/KR2023/021949

§ 371 Date: Aug. 18, 2025

(30) Foreign Application Priority Data
Dec. 30, 2022 (KR) 10-2022-0190462

(51) Int. Cl. H04W 52/02; H04M 1/72463; H04W 4/90

(52) U.S. Cl. CPC H04W 52/0264; H04M 1/72463; H04W 4/90

(57) ABSTRACT

The present invention relates to a power supply control device for driving a crime prevention application in a smart terminal. The present invention relates to a power supply control device and method for driving a crime prevention application in a smart terminal that allows only essential functions for calling for emergency rescue when the emergency button is activated. The present invention is provided with: an independent emergency button; and an over-discharge limiting unit that cuts off normal driving power supply to a smart terminal when a battery reaches a set discharge limit. When the emergency button is activated while the over-discharge limiting unit is activated or the smart terminal is turned off, only the essential functions for emergency rescue are allowed such that when a user simply presses the emergency button in an emergency situation, a rescue request signal, including user location information (GPS) and on-site audio, is quickly sent to multiple pre-registered emergency contacts (such as 112 for police, or a guardian) to thus effectively notify of the emergency situation, regardless of whether the power supply to a user terminal, such as a mobile phone or a smart watch, is turned off or the location information function is blocked.

### TECHNICAL FIELD

The present disclosure relates to a power supply control device for driving a crime prevention application in a smart terminal and, more particularly, to a power supply control device and method thereof for driving a crime prevention application in a smart terminal, the device and method enabling transmission of emergency rescue request signals even in a state where the power of the smart terminal is turned off.

### BACKGROUND ART

Children, women, the elderly, and others who have been harmed by criminals live their entire lives in pain due to trauma that goes beyond mental and physical pain. With the recent increase in emergency situations such as dating violence, revenge killings, and random killings, the need for a safety system that may ensure personal safety is rapidly increasing.

In order to solve such problems, a technology is implemented that allows for easy and quick transmission of rescue signals anytime and anywhere, in emergency situations or situations where threat is felt, by applying a program capable of transmitting emergency call signals with a smart terminal.

According to the disclosure in Korean Patent No. 10-0379946, a technology is disclosed for transmitting an emergency rescue request signal to a preset emergency contact by pressing an emergency button attached to a mobile communication terminal in order to escape from a criminal threat.

However, the existing method of transmitting an emergency call signal has a problem that it does not work when a terminal's power is discharged or intentionally turned off. In addition, in a case where a GPS function is deactivated, a user's location information is unable to be transmitted to the emergency contact, so there is an inconvenience of having to manually activate the GPS function.

In order to solve such a problem, it is urgent to develop technology that may always transmit emergency rescue request signals in cases where a smart terminal is powered off, a GPS function is turned off, and a victim is confronted by a criminal or is being chased.

In addition, there is also a need to address a problem of forcibly turning off a terminal's power through threats in a situation where an emergency rescue request signal has been transmitted, thereby stopping the transmission of a rescue signal.

### DOCUMENTS OF RELATED ART

### Patent Documents

(Patent Document 1) Korean Patent No. 10-0379946 (published on Apr. 11, 2003)

### DISCLOSURE

### Technical Problem

The present disclosure is for solving the above-described problems, and an objective of the present disclosure is to provide a power supply control device for driving a crime prevention application using a smart terminal, the device limiting excessive discharge of a battery of the smart terminal so as to secure essential power for requesting emergency rescue in an emergency.

Another objective of the present disclosure is to enable a smart terminal to be quickly booted by switching to an emergency power supply mode when an emergency button is pressed even in a situation where the terminal is in an over-discharge limit state or the terminal is powered off, so that an emergency rescue request signal can be quickly transmitted to an emergency contact.

A yet another objective of the present disclosure is to maintain an emergency mode continuously even though a power-off button of a terminal is pressed in a state where the emergency mode is activated.

### Technical Solution

In the present disclosure for achieving the above objectives, there is provided a power supply control device for driving a crime prevention application in a smart terminal, the device including: an independent emergency button; an over-discharge limiting unit for blocking normal power supply to the smart terminal when a battery reaches a set discharge limit; and

a control unit for controlling an emergency power supply mode of the smart terminal according to an emergency button input signal and a signal received from the over-discharge limiting unit, wherein the power supply control device further includes an emergency power supply mode switching processor for allowing only essential functions for requesting emergency rescue when the emergency button is operated in a state where the over-discharge limiting unit is in operation or power of the smart terminal is turned off.

The control unit may activate GPS when the emergency button is operated.

When the emergency button is operated, the device may be operated in a quick boot mode through application restriction (LMK).

The emergency power supply mode may block all call connection requests other than a request for a call connection to an emergency contact.

The emergency power supply mode may maximally reduce brightness of a display screen of the smart terminal.

When the emergency button is operated, vibrations may be generated, so as to allow a user to recognize that an emergency rescue request signal is being transmitted.

Whether location information (GPS) of the smart terminal is activated or not may be detected, so as to activate the location information when the location information is not activated.

When the smart terminal establishes the call connection to the emergency contact, a wiretapping mode may be activated on the emergency contact.

The emergency rescue request signal may include location information of the smart terminal.

When the emergency button is operated again in the emergency power supply mode, the emergency power supply mode may be switched to a normal call mode.

There is provided a method of using a power supply control device for driving a crime prevention application using a smart terminal provided with an emergency button, an over-discharge limiting unit, a control unit, and an emergency power supply mode switching processor, the method including: (a) a step of switching to an emergency power supply mode only allowing essential functions for requesting emergency rescue when the emergency button is operated in a state where the power supply control device for driving the crime prevention application using the smart terminal is in an over-discharge limit mode or power of the smart terminal is turned off; and (b) a step of determining whether GPS is activated or not in the emergency power supply mode so as to activate the GPS, blocking all call connection requests other than a request for a call connection to an emergency contact, and activating a wiretapping mode when the call connection to the emergency contact is established, so as to transmit GPS location information and an emergency rescue request signal.

The step (a) may include activating application restriction (LMK) for the essential functions for screen adjustment and an emergency rescue request by switching to a quick boot mode.

In the step (b), when the emergency button is operated, all the call connection requests other than the request for the call connection to the emergency contact may be blocked, and when the call connection to the emergency contact is established, the wiretapping mode may be activated, so as to transmit the emergency rescue request signal including the GPS location information and a voice signal or text signal in one direction from a user's smart terminal to the emergency contact.

After the step (c), the method may further include generating, by the power supply control device for driving the crime prevention application, vibrations so as to enable the user to recognize that the emergency rescue request signal is being transmitted.

After the step (c), when the emergency button is operated again in the emergency power supply mode, the emergency power supply mode may be switched to a normal call mode.

### Advantageous Effects

According to the present disclosure, when an emergency situation occurs, simply pressing an emergency button transmits a rescue request signal including a user's location information (GPS) and on-site voice to each of a plurality of pre-registered emergency contacts (e.g., an emergency phone number 112 for police, or a guardian) regardless of whether the power supplied to a user terminal such as a mobile phone or smartwatch is turned off or regardless of whether a location information function is blocked, thereby having an effect of quickly notifying of the emergency situation.

### DESCRIPTION OF DRAWINGS

FIG. 1 is a view illustrating an over-discharge limiting unit of a power supply control device for driving a crime prevention application using a smart terminal according to one exemplary embodiment of the present disclosure.

FIG. 2 is a block diagram illustrating a configuration of the power supply control device for driving the crime prevention application using the smart terminal according to one exemplary embodiment of the present disclosure.

FIG. 3 is a flowchart schematically illustrating a method of using a power supply control device for driving a crime prevention application using a smart terminal according to one exemplary embodiment of the present disclosure.

FIG. 4 is a flowchart illustrating an operation of an over-discharge limiting unit of the power supply control device for driving the crime prevention application using the smart terminal according to one exemplary embodiment of the present disclosure.

FIG. 5 illustrates an emergency button of a smart terminal according to one exemplary embodiment of the present disclosure.

### BEST MODE

Hereinafter, the present disclosure will be described in detail with reference to the accompanying drawings. However, the present disclosure is not restricted or limited by exemplary embodiments. The same reference numerals in each drawing indicate members that perform substantially the same functions.

Objectives and effects of the present disclosure may be naturally understood or more clearly understood by the following description, and the objectives and effects of the present disclosure are not limited only by the following description. In addition, in describing the present disclosure, when it is determined that a detailed description of a known technology related to the present disclosure may unnecessarily obscure the subject matter of the present disclosure, the detailed description thereof will be omitted.

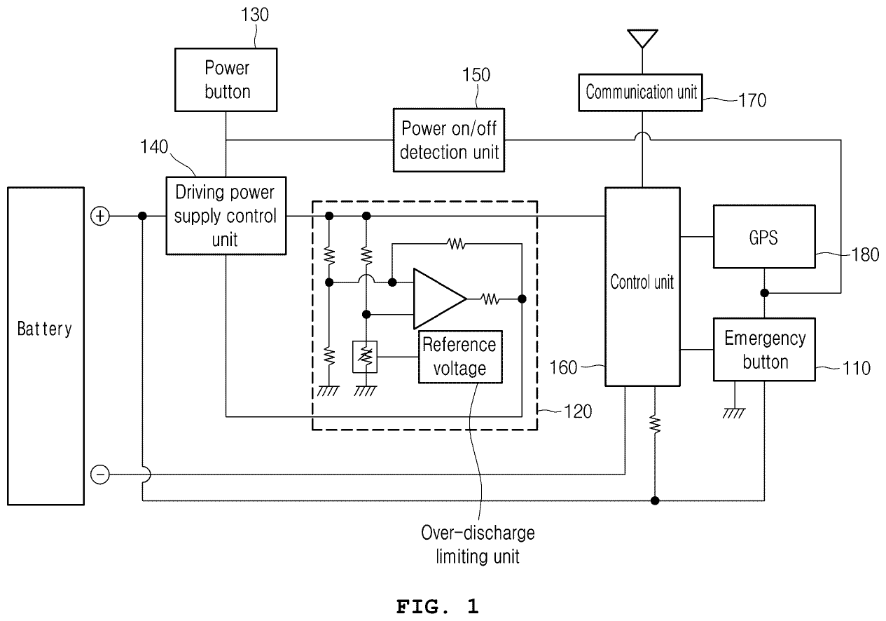

FIG. 1 is a view illustrating an over-discharge limiting unit of a power supply control device for driving a crime prevention application using a smart terminal according to one exemplary embodiment of the present disclosure.

As illustrated in FIG. 1, the power supply control device for driving the crime prevention application using the smart terminal includes an independent emergency button 110, an over-discharge limiting unit 120, a power button 130, a driving power supply control unit 140, a power on/off detection unit 150, a control unit 160, a communication unit 170, and a GPS 180.

The emergency button 110 is an emergency button independent from the power button, is a component for activating a crime prevention application operation mode in an emergency, and is preferable that this button is configured to be operated quickly by touch alone in a bag or pocket without looking at this button.

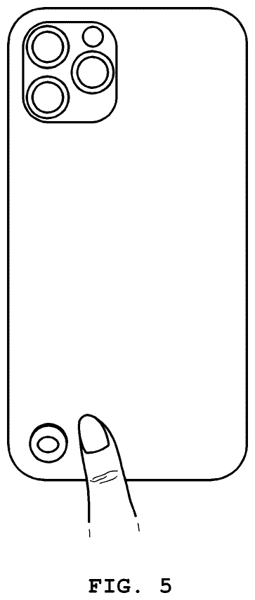

FIG. 5 illustrates an emergency button on the back of a smart terminal.

The over-discharge limiting unit 120 sets a reference voltage limit for battery supply power, and blocks normal driving power supply of a smart terminal when the reference voltage of a battery thereof reaches the limit. As an example, the limit is set to 5% battery capacity remaining, and when the limit is reached, general functions of the terminal are blocked, so as to prevent further discharge. This is used for transmitting an emergency rescue request signal in case of an emergency.

The power button 130 is a component for turning the power of the user terminal (or the smart terminal) on/off.

The driving power supply control unit 140 controls the supply of driving power by signals transmitted from the over-discharge limiting unit 120 and the control unit 160.

The control unit 160 is a component for controlling an emergency power supply mode of the smart terminal according to an emergency button input signal and a signal received from the over-discharge limiting unit. The control unit 160 receives a press signal of the emergency button 110, operates an emergency power supply mode switching processor to quickly boot the terminal under an application restriction (LMK) condition, turns off the terminal's display screen or adjusts the brightness of the display screen to a minimum, and controls activation of the GPS 180.

Usually, in a case of booting a smart terminal, it takes a considerable amount of time, more than five minutes, for numerous applications or S/W updates. However, the embodiment of the present disclosure maximally reduces booting time by using a method that allows only the minimum number of applications essential for emergency rescue requests to operate through application restriction (LMK) forcibly suppressing the operation of the applications not absolutely necessarily required when the emergency button 110 is operated.

The control unit 160 controls a vibration generation unit for generating vibrations so as to enable a user to recognize that an emergency rescue request signal has been normally transmitted when the emergency button 110 is pressed by the user, thereby helping the user respond calmly, executes a wiretapping mode under the emergency mode so as to suppress a speaker and display of the user terminal from operating, and controls that one-way information (voice, text, etc.) is transmitted from the user terminal to an emergency contact. The emergency rescue request signal may include location information of the smart terminal of the user.

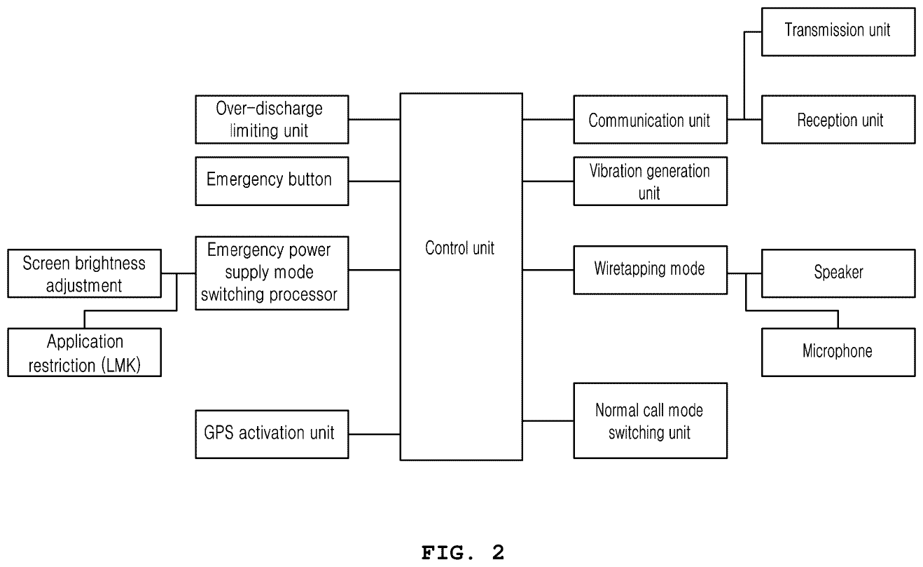

FIG. 2 is a block diagram illustrating a configuration of the power supply control device for driving the crime prevention application using the smart terminal according to one exemplary embodiment of the present disclosure.

In FIG. 2, a connection relationship is illustrated by reconfiguring components in block diagram form in order to describe functions of the control unit 160 in the power supply control device for driving the crime prevention application using the smart terminal according to one exemplary embodiment of the present disclosure.

As illustrated in FIG. 2, the control unit 160 receives a press signal of the emergency button and performs the screen control and the application restriction (LMK) through the emergency power supply mode switching processor. At this time, in a state where the over-discharge limiting unit is in operation or the power of the smart terminal is turned off, the control unit 160 controls the device to operate in a quick boot mode when the emergency button is operated.

Here, in the state where the over-discharge limiting unit is in operation or the power of the smart terminal is turned off, the quick boot mode of the control unit blocks the operation of all applications except for the display screen adjustment, GPS activation, functions of the communication unit for transmission and reception, functions of the vibration generation unit, and wiretapping mode functions, so as to allow only essential functions for an emergency power rescue request to perform when the emergency button is operated.

Here, in the present exemplary embodiment, memory restriction is applied through the application restriction (Limited Memory Killer), whereby control is performed so that only the essential functions for requesting emergency rescue are allowed when the emergency button is operated in the state where the over-discharge limiting unit is in operation or the power of the smart terminal is turned off.

In addition, the emergency power supply mode switching processor of the control unit 160 blocks all call connection requests other than a request for a call connection to an emergency contact in the emergency power supply mode activated by the operation of the emergency button. At this time, when the smart terminal establishes the call connection to the emergency contact, the control unit controls a wiretapping mode to be activated on the emergency contact.

In addition, the control unit 160 restricts the operation of the power button so that the emergency mode is maintained even if the power button of the smart terminal is pressed by a criminal in the emergency power supply mode in which the emergency rescue request signal is transmitted. Even though the criminal at a criminal scene turns off the power to the user's smart terminal to prevent the user from using the smart terminal for communicating with the outside world, the transmission of a power-off input signal is restricted once the emergency mode is activated.

In addition, the control unit 160 includes a component, i.e., a normal call mode switching unit, for switching to a normal call mode when the emergency button is operated again in the emergency power supply mode. As an example, this is to allow the smart terminal to easily switch from the emergency mode to the normal call mode in a case where a situation of the threat from the criminal has ended.

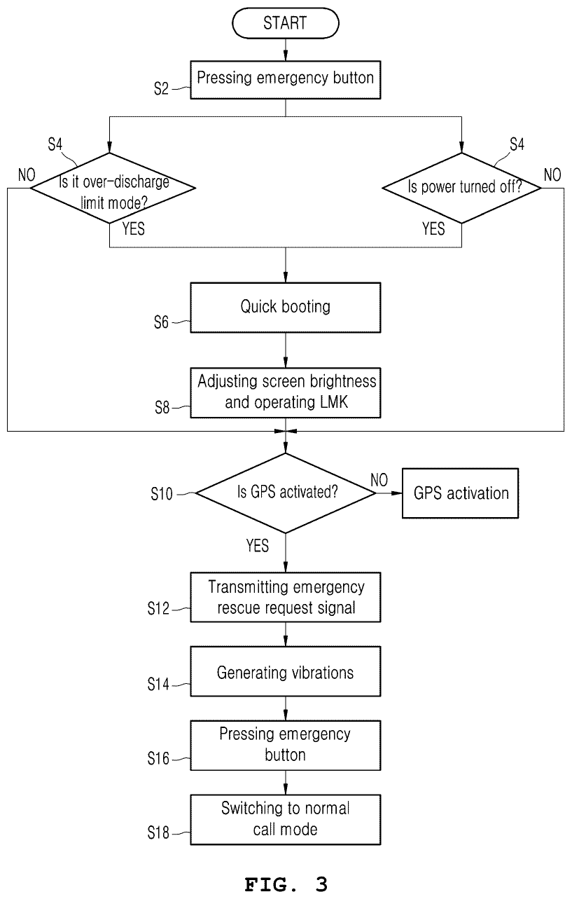

FIG. 3 is a flowchart schematically illustrating a method of using the power supply control device for driving the crime prevention application using the smart terminal according to one exemplary embodiment of the present disclosure.

As illustrated in FIG. 3, when an emergency button press signal is activated in step S2, a power supply control device for a crime prevention application using a smart terminal determines whether it is in a power limit mode due to over-discharge or is in a power-off state in step S4.

Next, the power supply control device for driving the crime prevention application using the smart terminal switches to a quick boot mode in step S6 when an emergency button is operated in a state where an over-discharge limiting unit is activated or the power of the smart terminal is turned off, and operates application function restriction (LMK) for essential functions for screen brightness adjustment and an emergency rescue request in step S8.

Next, the power supply control device for driving the crime prevention application using the smart terminal determines whether GPS is activated in emergency power supply mode in step S10 so as to activate GPS, blocks all call connection requests other than a request for a call connection to an emergency contact, and transmits an emergency rescue request signal including GPS location information and a voice signal or text signal in step S12 when the call connection to the emergency contact is established. At this time, a wiretapping mode is activated, so that the operation of a speaker and display of the user's terminal is restricted, and one-way information transmission is made from the user to the emergency contact.

Next, in step S14, the power supply control device for driving the crime prevention application using the smart terminal generates vibrations, so that the user may recognize that the emergency rescue request signal is being transmitted.

Next, in a case where the emergency button press signal is input again due to the emergency situation that has ended in step S16, the power supply control device for the crime prevention application using the smart terminal controls the functions of the smart terminal to be switched to those in the normal call mode in step S18.

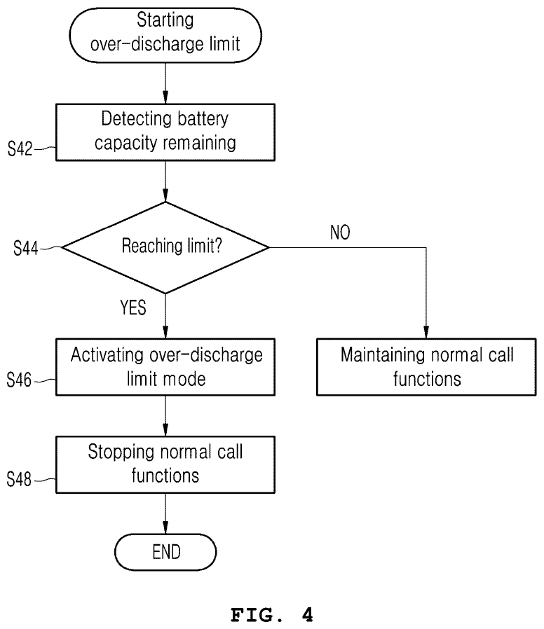

FIG. 4 is a flowchart illustrating an operation of the over-discharge limiting unit of the power supply control device for driving the crime prevention application using the smart terminal according to one exemplary embodiment of the present disclosure.

As illustrated in FIG. 4, in step S42, the over-discharge limiting unit detects a battery capacity remaining. Afterwards, it is determined whether the battery capacity remaining reaches a preset limit in step S44, and in a case of not reaching the limit, the normal call functions of the smart terminal are maintained, and in a case of reaching the limit, the over-discharge limit mode is activated in step S46 and the normal call functions of the smart terminal are stopped in step 48.

FIG. 5 is a view illustrating an example of the implementation of an emergency button of the power supply control device for driving the crime prevention application using the smart terminal according to one exemplary embodiment of the present disclosure. As illustrated in FIG. 5, the emergency button may be implemented in the form of a press button or cover, which is positioned on one side of the smart terminal and is implemented in a convex or concave shape so as to prevent malfunction in daily life. However, the form described above is only one exemplary embodiment and may be applied in various forms.

In the power supply control device for driving the crime prevention application in the smart terminal according to one exemplary embodiment of the present disclosure, when an emergency situation occurs, simply pressing the emergency button may transmit a rescue request signal including a user's location information (GPS) and on-site voice to each of a plurality of pre-registered emergency contacts (e.g., an emergency phone number 112 for police, or a guardian) regardless of whether the power supplied to the user terminal such as a mobile phone or smartwatch is turned off or regardless of whether a location information function is blocked, thereby having an effect of quickly notifying of the emergency situation.

1. A power supply control device for driving a crime prevention application in a smart terminal, the device comprising:
an independent emergency button;
an over-discharge limiting unit for blocking normal power supply to the smart terminal when a battery reaches a set discharge limit; and
a control unit for controlling an emergency power supply mode of the smart terminal according to an emergency button input signal and a signal received from the over-discharge limiting unit,
wherein the power supply control device further comprises:
an emergency power supply mode switching processor for allowing only essential functions for requesting emergency rescue when the emergency button is operated in a state where the over-discharge limiting unit is in operation or power of the smart terminal is turned off.

2. The device of claim 1, wherein the control unit further comprises a function of activating GPS when the emergency button is operated.

3. The device of claim 1, wherein when the emergency button is operated, the device is operated in a quick boot mode through application restriction (LMK).

4. The device of claim 1, wherein the emergency power supply mode blocks all call connection requests other than a request for a call connection to an emergency contact.

5. The device of claim 1, wherein the emergency power supply mode maximally reduces brightness of a display screen of the smart terminal.

6. The device of claim 1, wherein when the emergency button is operated, vibrations are generated, so as to allow a user to recognize that an emergency rescue request signal is being transmitted.

7. The device of claim 1, wherein whether location information (GPS) of the smart terminal is activated or not is detected, so as to activate the location information when the location information is not activated.

8. The device of claim 4, wherein when the smart terminal establishes the call connection to the emergency contact, a wiretapping mode is activated on the emergency contact.

9. The device of claim 6, wherein the emergency rescue request signal comprises location information of the smart terminal.

10. The device of claim 1, wherein when the emergency button is operated again in the emergency power supply mode, the emergency power supply mode is switched to a normal call mode.

11. A method of using a power supply control device for driving a crime prevention application using a smart terminal provided with an emergency button, an over-discharge limiting unit, a control unit, and an emergency power supply mode switching processor, the method comprising:
(a) a step of switching to an emergency power supply mode only allowing essential functions for requesting emergency rescue when the emergency button is operated in a state where the power supply control device for driving the crime prevention application using the smart terminal is in an over-discharge limit mode or power of the smart terminal is turned off; and
(b) a step of determining whether GPS is activated or not in the emergency power supply mode so as to activate the GPS, blocking all call connection requests other than a request for a call connection to an emergency contact, and activating a wiretapping mode when the call connection to the emergency contact is established, so as to transmit GPS location information and an emergency rescue request signal.

12. The method of claim 11, wherein the step (a) comprises:
activating application restriction (LMK) for the essential functions for screen adjustment and an emergency rescue request by switching to a quick boot mode.

13. The method of claim 11, wherein in the step (b), when the emergency button is operated, all the call connection requests other than the request for the call connection to the emergency contact are blocked, and
when the call connection to the emergency contact is established, the wiretapping mode is activated, so as to transmit the emergency rescue request signal comprising the GPS location information and a voice signal or text signal in one direction from a user's smart terminal to the emergency contact.

14. The method of claim 11, further comprising after the step (c):
generating, by the power supply control device for driving the crime prevention application, vibrations so as to enable the user to recognize that the emergency rescue request signal is being transmitted.

15. The method of claim 11, wherein after the step (c), when the emergency button is operated again in the emergency power supply mode, the emergency power supply mode is switched to a normal call mode.
